(19) United States
(12) Patent Application Publication
(10) Pub. No.: US 2002/0049276 A1
(43) Pub. Date: Apr. 25, 2002

(54) Thermoplastic elastomer gel compositions and method of making same

(76) Inventor: Paul D. Zwick, Atlanta, GA (US)

Correspondence Address: Mitra N. Vahdat, Miller & Martin LLP, Volunteer Building, Suite 1000, 832 Georgia Avenue, Chattanooga, TN, 37402, US

(21) Appl. No.: 09/826,754

(22) Filed: Apr. 5, 2001

Related U.S. Application Data
(60) Provisional application No. 60/194,832, filed on Apr. 5, 2000.

(51) Int. Cl. C08L 91/00; C08L 25/00

(52) U.S. Cl. 524/476; 524/574; 524/575

(57) ABSTRACT

A novel thermoplastic elastomer gel composition and method of making same is disclosed which contains a blend of SBS (styrene-butadiene-styrene) or an SBS polymer and a plasticizing oil. The thermoplastic elastomer gel composition exhibits a combination of properties including unexpectedly low tack. The thermoplastic elastomer gel composition requires less plasticizing oil and lower processing temperatures. Accordingly, the thermoplastic elastomer gel composition of the present invention is less costly. Additional polymers such as SEBS (styrene-ethylene-butylene-styrene), SEPS (styrene-ethylene-propylene-styrene) and SIS (styrene-isoprene-styrene) and block copolymers and blends thereof may also be used.

### RELATED APPLICATION

This application claims priority to provisional application Ser. No. 60/194,832 filed Apr. 5, 2000.

### BACKGROUND OF THE INVENTION

1. Field of the Invention

The present invention relates generally to thermoplastic elastomer gel compositions comprising SBS (styrene-butadiene-styrene), SEBS (styrene-ethylene-butylene-styrene), SIS (styrene-isoprene-styrene), SEPS (styrene-ethylene-propylene-styrene) and methods of making same.

2. Description of Related Art

Thermoplastic elastomer gels are used in prosthetics for amputees, orthopedic medical footwear, components for cushions, pads, computer wrist pads, dental floss, toys, therapeutic hand exercise grips, shock absorbers and acoustical isolators, among others. It is well known that thermoplastic elastomers, more particularly, thermoplastic block copolymers can be oil-extended to produce soft and flexible compositions. Thermoplastic elastomer gel compositions are typically made with SEBS, the hydrogenated form of SBS, and sometimes with SEPS. They are typically produced by combining SEBS or SEPS with high levels of oil. Very soft compounds, or gels are achieved by adding very high levels of plasticizing mineral oil to SEBS or SEPS, in the range of 300 to 1600 parts of mineral oil per 100 parts of SEBS or SEPS. This process can take many hours and much labor to complete.

SBS thermoplastic elastomers, due to their nature (chemical composition, molecular structure, etc.) inherently possess high ductility, high elastic recovery, good thermal stability and excellent flexibility at low temperatures. Although SBS costs much less than SEBS, other factors may have discouraged SBS' use for producing thermoplastic elastomer gel compositions. For example, SEBS and SEPS are typically made in ground powder form which is easy to mix with mineral oil. SEBS and SEPS readily absorb mineral oil because they are porous powders, whereas SBS is typically obtained in porous pellets which makes it more difficult to combine with mineral oil. In addition, SEBS and SEPS provide better UV and thermal stability.

### SUMMARY OF THE INVENTION

The present invention recognizes and addresses the foregoing disadvantages, and others, of prior art compositions and methods.

Accordingly, it is an object of the present invention to provide thermoplastic elastomer gel compositions and methods of making same which provide less costly and/or lower tack thermoplastic elastomer gels which are more processible, having better cycle times and lower processing temperatures utilizing SBS, SEBS and SEPS, or combinations thereof.

More particularly, it is an object of the present invention to utilize SBS, a less easily handled product to produce thermoplastic elastomer gel compositions, and specialized methods of production.

Most particularly, it is an object of the present invention to utilize SBS in producing thermoplastic elastomer gel compositions which require lower processing temperatures which result in better cycle time, have less tack and have the ability to produce the same durometer material as produced with SEBS while utilizing a lower amount of mineral oil or other plasticizing oil.

And, it is an object of the present invention to utilize SBS, SEBS, SEPS and SIS in producing thermoplastic elastomer gel compositions which have magnetic, thermal management and low tack properties.

A first advantage of a presently preferred embodiment is the use of SBS to produce thermoplastic elastomer gel compositions which are less costly than those utilizing SEBS.

A second advantage of a presently preferred embodiment includes the utilization of SBS, which requires a lower processing temperature to produce thermoplastic elastomer gel compositions.

Yet another advantage of a presently preferred embodiment includes the use of SBS to produce thermoplastic elastomer gel compositions with less tack.

Still another advantage of a presently preferred embodiment includes thermoplastic elastomer gel compositions produced from SBS which have the same durometer as thermoplastic elastomer gel compositions produced with SEBS, while utilizing a lower amount of plasticizing oil.

An advantage of using SEBS or SEPS to produce thermoplastic elastomer gel compositions according to the method of the present invention is that this process formulates very soft (low Shore A durometer, or Shore OO durometer)thermoplastic elastomer gel compounds which are heat and UV stable.

Yet another advantage of a presently preferred embodiment includes thermoplastic elastomer gel compositions produced from SBS, SEBS and SEPS having magnetic, thermal management and low tack properties.

Additional objects and advantages of the invention will be set forth in part in the following description, or may be obvious from the description, or may be learned through practice of the invention.

### DETAILED DESCRIPTION OF THE PREFERRED EMBODIMENTS

Reference will now be made in detail to the presently preferred embodiment of the invention. It will be apparent to those skilled in the art that modifications and variations can be made in the present invention without departing from the scope or spirit thereof. Thus, it is intended that the present invention cover such modifications and variations as come within the scope of the amended claims and their equivalents.

The present invention is mainly concerned with thermoplastic elastomer gel compositions produced with SBS, and also, thermoplastic elastomer gel compositions produced with SEBS or SEPS. This process produces thermoplastic elastomer gel compositions which require lower processing temperatures. Lower processing temperatures result in better cycle times and less tack to the field of the resulting products. The following method is used to produce thermoplastic elastomer gel compositions using SBS, SEBS or SEPS. SIS (styrene-isoprene-styrene) polymers which are chemically similar to SBS but have lower molecular weights may also be substituted for SBS, SEBS or SEPS polymers or alternatively be used as an additive. Nevertheless, SIS alone is undesirable because the high amount of SIS makes the material less handleable and therefore undesirable.

In the present invention the polymeric composition suitable for this application is preferably a substantially linear copolymer having the general configuration A-B-A, wherein the A block can be polystyrene and the B block can be ethylene-butylene, ethylene propylene, isoprene, butadiene or mixtures thereof. Preferably the B block is butadiene. Multi-armed, branched and star shaped polymeric compositions may also be used.

SBS block copolymers are available from Dexco Polymers under the VECTOR trademark, as well as several other manufacturers. SEBS block copolymers are available from Shell Chemical Co. under the KRATON trademark. SEPS and SEBS block copolymers are available from Kuraray America Inc. under the SEPTON trademark. SIS block copolymers are available from Shell Chemical Co., Dexco Polymers, EniChem, and others.

In the preferred embodiment, up to 200 parts by weight of a plasticizing oil, preferably mineral oil, per 100 parts by weight of SBS or an SBS blend, SEBS or an SEBS blend, or SEPS or an SEPS blend is first pre-blended in a high or medium shear/intensity blender, such as a Henschel or ribbon blender, until it is homogenous and relatively dry. On an average, this process takes anywhere from about 5 to 10 minutes.

This pre-blend is then fed into a high shear, heated mixing vessel or extruder. The blend is melted and masticated at above the softening or melting point of the material between 200-500° F. (typically about 300-400° F.). Additional oil is then injected into the mixing device, after the melting and mixing has occurred, but sufficiently early in the mixing stage to allow for complete incorporation and absorption of the oil. The majority of the oil can be injected into the heated mixing vessel or extruder. Anywhere between a total of 100 to 560 parts by weight of a plasticizing oil can be used which results in about 50% to 85% plasticizing oil with the balance being SBS, SEBS, SEPS or SIS, or combinations thereof.

The vessel or extruder can be an internal (bowl) mixer, Banbury mixer, twin screw extruder, co-kneader, buss-kneader or similar device. The preferred mixing device is a twin screw extruder, with an L/D ratio of at least 40:1, preferably 48:1. A twin screw extruder which has higher shear energy input works best. A single screw extruder which only has one shaft has not produced good results. The oil is typically injected into barrel 6 of a 10 barrel design or barrel 6 and 8 of a 12 barrel design. The screw design is such that it allows for high shear/dispersion, as well as oil injection, degassing, and underwater pelletizing. Use of high shear facilitates shorter heating times. High shearing with heat mixes the compounds at lower temperatures and faster rate than the use of heat alone or heat with relatively low shear mixing. It takes anywhere from 30 seconds to 5 minutes in the extruder at a temperature of anywhere between 200° F. to 500° F. for complete absorption of the oil. A temperature of 300° F. to 330° F. is preferred. Screw speeds of 100 to 400 and shear rates of 300 sec⁻¹ to 30,000 sec⁻¹ work best.

A variety of additives can be added to this composition during the melting and mastication process, including pigments and colorants, flame retardants, blowing agents, chemical foaming agents, phase change materials, magnetic particles, stabilizers and antioxidants, lubricants, waxes, fillers, minerals, emollients, antibacterial agents, antistatic agents, conductive additives, antiblocking agents, fragrances, other polymers, and other additives known in the art, etc. . . . , and mixtures thereof. These additives and others will be discussed in more detail below.

Any SBS polymer or any polymer combination including an SBS compound may be used. Higher molecular weight SBS polymers are preferred because they accept and retain higher levels of plasticizing oil. The following is a list of some of the highest molecular weight types of SBS which are best in producing thermoplastic elastomer gel compositions with SBS:

| | | | Approximate |
|---|---|---|---|
| | Material | Molecular | Molecular |
| Vendor | Description | Structure | Weight |
| Dexco Polymers | VECTOR 2411 | 30% Styrene/R* | 240,000 MW |
| Dexco Polymers | VECTOR 2518 | 30% Styrene/L | 105,000 MW |
| Dexco Polymers | VECTOR DPX563 | 30% Styrene/L | 130,000 MW |
| Enichem | SolT 161B | 30% Styrene/R | 240,000 MW |
| Enichem | SolTE 6306 | 30% Styrene/R | 250,000 MW |
| Enichem | SolT 161C | 30% Styrene/R | 160,000 MW |
| Enichem | SolT 620S | 30% Styrene/R | 165,000 MW |
| Enichem | SolT 6302 | 30% Styrene/L | 105,000 MW |
| Repsol Quyimica | CALPRENE 411 | 30% Styrene/R | 240,000 MW |
| Repsol Quyimica | CALPRENE 419 | 30% Styrene/R | 200,000 MW |
| Repsol Quyimica | CALPRENE 401 | 30% Styrene/R | 175,000 MW |
| Repsol Quyimica | CALPRENE 405 | 30% Styrene/R | 120,000 MW |
| Repsol Quyimica | CALPRENE 501 | 30% Styrene/L | 105,000 MW |
| Shell Chemical | KRATON D1184 | 30% Styrene/R | 240,000 MW |
| Shell Chemical | KRATON D1116 | 30% Styrene/R | 130,000 MW |
| Shell Chemical | KRATON D1101 | 30% Styrene/L | 105,000 MW |
| Shell Chemical | KRATON D4158 | 30% Styrene/R | ??? |

*R = Radial Polymer; L = Linear Polymer

In addition, any other lower molecular weight SBS polymers may be used. Lower molecular weight SBS polymers which may be used include:

| | | | Approximate |
|---|---|---|---|
| | Material | Molecular | Molecular |
| Vendor | Description | Structure | Weight |
| Dexco Polymers | VECTOR 8508 | 30% Styrene/L | 70,000 MW |
| Shell Chemical | KRATON D1102 | 30% Styrene/L | 70,000 MW |

Blends of different SBS polymers may also be used. SBS blends exhibit improved processability characteristics. Blend ratios typically vary from 90/10 to 50/50 of high molecular weight types of polymers to lower molecular types of polymers, respectively. For example, VECTOR 2411 (a radial 240,000 MW SBS polymer) can be used or a blend of VECTOR 2411 and VECTOR 2518 (a linear 105,000 MW to SBS polymer).

Using 250 parts of mineral oil to 100 parts of VECTOR 2411 produces a durometer that is sufficiently low so as to be equivalent to high molecular weight SEBS that is 280 parts of mineral oil per 100 parts of high molecular weight SEBS (such as the KRATON G1651 or KRATON G1654X brand products manufactured by Shell Chemical Company). Furthermore blends and polymer combinations of SBS, SEBS, SEPS and even SIS, and any polymer combination including any of these block copolymers and blends thereof, may be used depending on the type of elastomer gel composition desired. SBS provides lower cost and lower processing temperatures. SEBS and SEPS can provide better UV and heat stability. SIS and other block copolymers can provide improved vibration and energy absorption. For example, any SBS, SEBS, SEPS or SIS block copolymer or any polymer combination including a SBS, SEBS, SEPS or SIS block copolymer may be used. Alternatively, polymers or blends thereof may be used as additives. SEBS or SIS block copolymers and polymer combinations including a SEBS or SIS block copolymer may also be used.

Higher molecular weight SEBS may also be used such as KRATON G1651 and KRATON G1654X. Higher molecular weight SEPS such as SEPTON 8006, SEPTON 4055 and SEPTON 4044 may also be used. Higher molecular weight block copolymers will accept and retain higher levels of plasticizing oil. SEPS may provide slightly higher tensile strength and strain—induced crystallization.

Many different types of plasticizers can be used. The plasticizer component may contain one type of plasticizer or a mixture of plasticizer types. A plasticizer is broadly defined as a typically organic composition that can be added to thermoplastics, rubbers and other resins to improve extrudability, flexibility, workability and stretchability in the finished product. Any material which flows at ambient temperatures and is compatible with the polymer may be useful. Witco's CARNATION brand oil, which is a 70 SUS viscosity FDA Grade mineral oil is preferred. Other oils that can be used include Witco's BLANDOL and HYDROBRITE 100PO brand products, Penreco's DRAKEOL 7 and DRAKEOL 9 brand products, Chevron's PARALUX 701R brand product (a paraffinic oil), Lyondell's DUOPRIME 70 and DUOPRIME 90 brand products and other oils of low molecular weight (less than 400) and with Flash Points above 330° F. Lower molecular weight oils are preferred because they provide better compatibility with the block copolymer and faster absorption.

Not only mineral oil or “white” oils can be used, but also the paraffinic oils and even the naphthenic oils (such as Shell Chemical's SHELLFLEX brand product or Calumet's CALSOL brand products) may be used. Other oils may also be used and oils may be optimized for the particular elastomer gel composition. For example, other oils which may be used include petroleum paraffinic oils, petroleum naphthenic oils, synthetic polybutene oils, synthetic polypropene oils, synthetic polyterpene oils, aromatic oils and mixtures thereof. Other plasticizers include highly refined aromatic-free paraffinic and napthenic food and technical grade white petroleum mineral oils. Plasticizers such as polybutenes manufactured by Exxon or Amoco also work, however, they are expensive and more volatile.

A plasticizer of the invention may also be a resin. Liquid resins or resins may also be used such as cycloaliphatic hydrocarbons, hydrogenated aromatic resins and esterified resins.

Although a total of up to 560 parts by weight of a plasticizer may be used, an oil content range in the range of 150 to 400 parts is preferable. Consumers may also have facilities where they could add additional oil to the pellets to create a final product.

Additives

Many additives can be added to the thermoplastic elastomer gel compositions. One example is blowing agents or chemical foaming agents. These act to release a gas such as carbon dioxide, water or nitrogen during the molding or extrusion process to form a foamed or cellular part. These can be either endothermic such as sodium bicarbonate/citric acid blends (Clariant's BIH and BIF materials) or exothermic such as Azobisdicarbonamide (Uniroyal's CELOGEN AZ). These produce foamed versions of the thermoplastic elastomer gels yielding a lower density product at a lower cost. Another agent that can be used is the EXPANCEL brand product manufactured by Akzo. EXPANCEL is a plastic sphere that contains an inert gas that expands on heating. When the plastic sphere softens upon heating, the sphere increases in diameter thus acting as a foaming agent to reduce density.

Other additives that can be used are phase change materials. These are typically plastic spheres that contain waxes that melt at different temperatures, thus reacting like thermoregulators, absorbing heat that goes into melting the wax or giving off heat that goes into solidifying the wax. These materials include the THERMASORB brand products available from Frisby Technologies, Inc. These additives used in connection with the thermoplastic elastomer gel, and embedded in other plastic, produce thermal management gels at lower temperatures which prevent the break down of most of the thermal management additives.

A variety of magnetic additives can also be used in the thermoplastic elastomer gel composition. Typically, these additives are ferrite complexes, which when charged or energized by another strongly magnetic force, will become magnetic or dipolar and yield magnetic fields. Strontium and Barium Ferrite are the most common commercially used ferrites, but other ferrites can also be used. These magnetic compositions can be used as shoe inserts or any other product where magnetic benefits are desired. The magnetic additives, however, require additional manufacturing steps. Specifically, after being formed or extruded the gel containing the magnetic ingredients should be oriented through a powerful magnetic field.

Stabilizers or antioxidants can also be used as additives. These are added to polymer systems to prevent degradation during processing (heating and melting, and high shear mixing, as seen in compounding and molding or extruding finished articles) and end use. These include hindered phenolic stabilizers, sold under the trade names IRGANOX 1010 and IRGANOX 1076 manufactured by Ciba Geigy. In addition, alpha-tocopherol (Vitamin E), a natural antioxidant, can be used. Other antioxidants such as organic phosphites including di tert butyl phenyl phosphite (commercially known as IRGAFOS 168, manufactured by Ciba Geigy) may also be used. Furthermore, a combination of hindered phenolic antioxidants at high levels will render the surface non-tacky. By adding the proper level of hindered phenolic and phosphite, those additives will bloom to the surface of the gel and render the surface non-tacky. Generally, this level will be greater than 0.25% by weight, up to 0.75% by weight, most preferably 0.5% by weight of the hindered phenolic and 0.2-0.4% by weight of the phosphite, most preferably 0.25% by weight.

Other additives that can be used include lubricants and waxes. Lubricants and waxes are of lower molecular weight and sufficiently incompatible to come to the surface of the polymer and improve processing characteristics such as mold release or surface characteristics (die drag). Different types of lubricants or waxes include fatty acid amides (like Witcohs KEMAMIDE E, stearyl he erucamide; or Croda Universal's CRODAMIDE EBS, ethylenebis stearamide), polyolef in waxes (mostly polyethylene waxes of very low molecular weight like those manufactured by Eastman Chemical under the brand name EPOLENE C series, those manufactured by Allied Signal under the brand name AC series, or those manufactured by Shamrock Technologies under the brand name S395-N5), silicone fluids, and others. Generally, between 0.1 to 2.0% by weight of lubricants are used to produce gels with low tack.

Other additives include fillers and minerals, such as calcium carbonate and talc, flame retardants such as alumina trihydrate, magnesium hydroxide, halogenated organic molecules such as decabromodiphenyloxide, and nitrogen/phosphorus combinations, such as ammonium polyphosphate or melamine phosphates, and colorants, antistatic agents, conductive additives, other polymers and copolymers, antiblocking agents, fragrances and mixtures thereof. A variety of additives such as polymers or fillers may also be used in order to modify the shock absorbing properties of the elastomer gel.

Other optional additives include emollients and beneficial materials such as lanolin, coconut oil, cocoa butter, antibacterial agents, aloe vera and others.

Also, other polymers and copolymers can be utilized in blends such as rubbers with glass transition temperatures close to room temperature, for example, high 1, 2 vinyl butadiene based SBS (or SEBS or SEPS) and polyisobutylene. These polymers can be added to provide improved vibration dampening properties. Materials such as polyisobutylene sold under the trademark VISTANEX and manufactured by Exxon or HYBRAR VS-1 or HVS-3 (SBS with high vinyl and SEBS with high vinyl, respectively, manufactured by Kuraray Chemical of Japan) are examples. The polymers can be added at a ratio from about 50 to 200 parts per 100 parts of SBS to achieve the desired results.

Other additives include metallic pigments such as aluminum and brass flakes, TiO₂, mica, flourescent dyes and pigments, phosphorescent pigments, aluminatrihydrate, antimony oxide, iron oxides, iron cobalt oxides, chromium dioxide, iron, barium ferrite and strontium ferrite. In addition, thermoplastic elastomer gel compositions using SBS, SEBS, SEPS or embedded in other plastic, can be produced according to the method of the present invention with substantially the same novel additives to yield thermoplastic elastomer gel compositions with magnetic, thermal management and low tack qualities.

The instant composition is excellent for cast molding and extrusion. The molded and extruded products have various excellent characteristics which cannot be anticipated from the properties of the raw components. Other conventional methods of forming the composition can be also be utilized.

The invention is further illustrated by means of the following illustrative embodiments, which are given for the purpose of illustration only and are not meant to limit the invention to the is particular components and amounts disclosed. The following examples show the preferred embodiments for producing novel thermoplastic elastomer gel compositions using SBS and/or SEBS and/or SEPS and/or SIS.

### EXAMPLE 1

A typical SBS gel formulation for lower durometer thermoplastic elastomer gel compositions has the following composition:

| Vendor | Material Description | % by Weight |
|---|---|---|
| Dexco Polymers | VECTOR 2411 | 28.36% |
| Witco | CARNATION Mineral Oil | 70.89% |
| Ciba Geigy | IRGANOX 1010 | 0.50% |
| Ciba Geigy | IRGAFOS 168 | 0.25% |
| Witco | Calcium Stearate | 0.10% |

This formulation produces a thermoplastic elastomer gel composition with a lower cost than traditional gel materials, has a lower tack so it is less sticky, allows lower process temperatures and faster cycle times. However, this thermoplastic elastomer gel composition has poor UV resistance.

The following are the properties for the thermoplastic elastomer gel composition produced according to the formulation of Example 1:

| | | Nominal Value | | | | |
|---|---|---|---|---|---|---|
| | | English Units | | SI Units | | Method |
| Property | Conditions | VALUE | unit | VALUE | unit | (ASTM) |
| General | | | | | | |
| Specific | | .88 | | .88 | | D 792 |
| Gravity | | | | | | |
| Melt Flow Rate | 150° C./ | 350 | g/10 | 350 | g/10 | D 1238 |
| | 2.16 | | min | | min | |
| Physical | | | | | | |
| Tensile | | 111 | psi | | | D 412 |
| Strength | | | | | | |
| Elongation | | 973 | % | | | D 412 |
| 100% Modulus | | 16.4 | psi | | | D 412 |
| 300% Modulus | | 30.0 | psi | | | D 412 |
| Tear Strength | Die C | 32 | Pli | | | D 624 |
| Hardness, | Shore A | 4 | | | | D 2240 |
| 5 sec. delay | | | | | | |

### EXAMPLE 2

A typical SBS gel formulation for a higher durometer thermoplastic elastomer gel composition depending on the application, has the following composition:

| Vendor | Material Description | % by Weight |
|---|---|---|
| Dexco Polymers | VECTOR 2411 | 16.50% |
| Dexco Polymers | VECTOR 2518 | 16.50% |
| Witco | CARNATION Mineral Oil | 66.00% |
| Ciba Geigy | IRGANOX 1010 | 0.50% |
| Ciba Geigy | IRGAFOS 168 | 0.25% |
| Witco | Calcium Stearate | 0.25% |

### EXAMPLE 3

A typical SES or SEBS thermoplastic elastomer gel which can be processed to hold a magnetic field has the following composition:

| Vendor | Material Description | Parts by Weight |
|---|---|---|
| Dexco Polymers/ | VECTOR 2411 (SBS) | 100 parts |
| Shell Chemical | or KRATON G 1654X (SEBS) | |
| Witco | CARNATION Mineral Oil | 250-280 parts |
| Widely Available | Strontium Ferrite | 350-450 parts |
| Ciba Geigy | IRGANOX 1010 | 3-5 parts |
| Ciba Geigy | IRGAFOS 168 | 1.5-2.5 parts |
| Witco | Calcium Stearate | 1.5-2.5 parts |

### EXAMPLE 4

A typical SBS or SEBS thermoplastic elastomer gel with thermal management qualities has the following composition:

| Vendor | Material Description | Parts by Weight |
|---|---|---|
| Dexco Polymers | VECTOR 2411 (SBS) | 100 parts |
| Shell Chemical | or KPATON C 1654X (SEBS) | |
| Witco | CARNATION Mineral Oil | 250-400 parts |
| Frisby Technologies | THERMASORB 83 | 50-300 parts |
| Ciba Geigy | IRGANOX 1010 | 2-4 parts |
| Ciba Geigy | IRGAFOS 168 | 1-2 parts |
| Witco | Calcium Stearate | 1-2 parts |

### EXAMPLE 5

In order to produce a SBS or SEBS low-tack gel, a preferred formula is:

| Vendor | Material Description | Parts by Weight |
|---|---|---|
| Dexco Polymers | VECTOR 2411 (SBS) | 100 parts |
| Shell Chemical | or KRATON G 1644X (SEBS) | |
| Witco | CARNATION Mineral Oil | 150-560 parts |
| Ciba Geigy | IRGANOX 1010 | 0.5-3 parts |
| Ciba Geigy | IRGAFOS 168 | 0.5-2 parts |
| Witco | Calcium Stearate | 0.5-2 parts |

### EXAMPLE 6

A typical SBS gel formulation with a slightly higher durometer than the thermoplastic elastomer gel composition produced by the formulation of Example 1, has the following composition:

| Vendor | Material Description | % by Weight |
|---|---|---|
| Dexco Polymers | VECTOR 2411 | 16.09% |
| Witco | CARNATION Oil | 67.59% |
| Ciba Geigy | IRGANOX 1010 | 0.10% |
| Ciba Geigy | IRGAFOS 168 | 0.10% |
| Sun Chemical | Blue L49-0714 | 0.03% |
| Dexco Polymers | VECTOR 2518 | 16.09% |
| Witco | Calcium Stearate Surface Duster | 0.10% |

The higher durometer results in improved tensile and tear strength. In comparison to the traditional gels produced with SEBS, the thermoplastic elastomer gel composition according to this formulation is also lower in tack, has lower process temperatures and has a faster cycle time.

The following are the properties for the thermoplastic elastomer gel compositions produced according to the formulation of Example 6:

| | | Nominal Value | | | | |
|---|---|---|---|---|---|---|
| | | English Units | | SI Units | | Method |
| Property | Conditions | VALUE | unit | VALUE | unit | (ASTM) |
| General | | | | | | |
| Specific | | .88 | | .88 | | D 792 |
| Gravity | | | | | | |
| Melt Flow Rate | 150° C./ | 240 | g/10 | 240 | g/10 | D 1238 |
| | 2.16 | | min | | min | |
| Physical | | | | | | |
| Tensile | | 325 | psi | 2.24 | MPa | D 412 |
| Strength | | | | | | |
| Elongation | | 1011 | % | 1011 | % | D 412 |
| 100% Modulus | | 32.4 | psi | 0.22 | MPa | D 412 |
| 300% Modulus | | 55.0 | psi | 0.38 | MPa | D 412 |
| Tear Strength | Die C | 45 | Pli | 8.1 | Kg/ | D 624 |
| | | | | | cm | |
| Hardness, | Shore A | 7 | | 7 | | D 2240 |
| 5 sec. delay | | | | | | |

### EXAMPLE 7

A typical SBS gel formulation having improved UV resistance has the following composition.

| Vendor | Material Description | % by Weight |
|---|---|---|
| Dexco Polymers | VECTOR 2411 | 16.39% |
| Witco | CARNATION Oil | 66.59% |
| Ciba Geigy | IRGANOX 1010 | 0.10% |
| Ciba Geigy | IRGAFOS 168 | 0.10% |
| Sun Chemical | Blue L49-0714 | 0.03% |
| Dexco Polymers | VECTOR 2518 | 16.39% |
| Ciba Geigy or | TINUVIN 328/CHISORB 328 | 0.20% |
| Maroon Chem. | | |
| Ciba Geigy or | CHIMASSORB 944/CHISORB 944 | 0.20% |
| Maroon Chem. | | |
| Witco | Calcium Stearate Partitioning Agent | 0.10%-0.30% |

The following are the properties for the thermoplastic elastomer gel compositions produced according to the formulation of Example 7:

| | | Nominal Value | | | | |
|---|---|---|---|---|---|---|
| | | English Units | | SI Units | | Method |
| Property | Conditions | VALUE | unit | VALUE | unit | (ASTM) |
| General | | | | | | |
| Specific | | .88 | | .88 | | D 792 |
| Gravity | | | | | | |
| Melt Flow Rate | 150° C./ | 240 | g/10 | 240 | g/10 | D 1238 |
| | 2.16 | | min | | min | |
| Physical | | | | | | |
| Tensile | | 325 | psi | 2.24 | MPa | D 412 |
| Strength | | | | | | |
| Elongation | | 1011 | % | 1011 | % | D 412 |
| 100% Modulus | | 32.4 | psi | 0.22 | MPa | D 412 |
| 300% Modulus | | 55.0 | psi | 0.38 | MPa | D 412 |
| Tear Strength | Die C | 45 | Pli | 8.1 | Kg/ | D 624 |
| | | | | | cm | |
| Hardness, | Shore A | 7 | | 7 | | D 2240 |
| 5 sec. delay | | | | | | |

This formulation produces a low cost thermoplastic elastomer gel composition having improved UV resistance. The gel composition also has low tack, low processing temperatures and a fast cycle time.

### EXAMPLE 8

A typical SBS or SEBS gel formulation having extremely low tack so that it has a dry, non-sticky surface has the following composition:

| Vendor | Material Description | % by Weight |
|---|---|---|
| Dexco Polymers | VECTOR 2411 | 16.35% |
| Shell Chemical | or KRATON G1654X | |
| Witco | CARNATION Oil | 65.38% |
| Ciba Geigy | IRGANOX 1010 | 0.50% |
| Ciba Geigy | IRGAFOS 168 | 0.25% |
| Dexco Polymers | VECTOR 2518 | 16.35% |
| Shell Chemical | or KRATON 1650 | |
| Columbia Chemical | RAVEN 1170 | 0.055% |
| DuPont | TIPURE R-101 | 0.117% |
| Croda Universal | CRODAMIDE EBS | 1.00% |
| Shamrock | SHAMROCK WAX S395-N5 | 1.00% |
| Technologies | (dusting agent) | |

The following are the properties for the thermoplastic elastomer gel composition produced according to the formulation of Example 8:

| | | Nominal Value | | | | |
|---|---|---|---|---|---|---|
| | | English Units | | SI Units | | Method |
| Property | Conditions | VALUE | unit | VALUE | unit | (ASTM) |
| General | | | | | | |
| Specific | | .89 | | .89 | | D 792 |
| Gravity | | | | | | |
| Melt Flow Rate | 150° C./ | 300 | g/10 | 300 | g/10 | D 1238 |
| | 2.16 | | min | | min | |
| Physical | | | | | | |
| Tensile | | 295 | psi | 2.03 | MPa | D 412 |
| Strength | | | | | | |
| Elongation | | 1059 | % | 1059 | % | D 412 |
| 100% Modulus | | 38.0 | psi | 0.26 | MPa | D 412 |
| 300% Modulus | | 60.0 | psi | 0.41 | MPa | D 412 |
| Tear Strength | Die C | 47 | Pli | 8.4 | Kg/ | D 624 |
| | | | | | cm | |
| Hardness, | Shore A | 9 | | 9 | | D 2240 |
| 5 sec. delay | | | | | | |

This formulation produces a low cost thermoplastic elastomer gel composition with extremely low tack so that it has a dry, non-sticky surface. The gel composition still maintains low processing temperatures.

### EXAMPLE 9

A typical SBS or SEBS/SEPS gel formulation having improved vibration dampening and energy absorption properties in comparison to the gel formulated in accordance with Example 1, has the following composition:

| Vendor | Material Description | % by Weight |
|---|---|---|
| Dexco Polymers | VECTOR 2411 or | 16.09% |
| Kuraray America | SEPTON 4055 | |
| Witco | CARNATION Oil | 67.59% |
| Ciba Geigy | IRGANOX 1010 | 0.10% |
| Ciba Geigy | IRGAFOS 168 | 0.10% |
| Sun Chemical | BLUE L49-0714 | 0.03% |
| Kuraray America | HYBRAR 5127 (VS-1 Polymer) | 16.09% |
| Witco | Calcium Stearate Surface Duster | 0.10% |

The following are the properties for the thermoplastic elastomer gel composition produced according to the formulation of Example 9:

| | | Nominal Value | | | | |
|---|---|---|---|---|---|---|
| | | English Units | | SI Units | | Method |
| Property | Conditions | VALUE | unit | VALUE | unit | (ASTM) |
| General | | | | | | |
| Specific | | .88 | | .88 | | D 792 |
| Gravity | | | | | | |
| Melt Flow Rate | 150° C./ | 375 | g/10 | 375 | g/10 | D 1238 |
| | 2.16 | | min | | min | |
| Physical | | | | | | |
| Tensile | | 200 | psi | 1.38 | MPa | D 412 |
| Strength | | | | | | |
| Elongation | | 750 | % | 750 | % | D 412 |
| 100% Modulus | | 19 | psi | 0.13 | MPa | D 412 |
| 300% Modulus | | 33 | psi | 0.23 | MPa | D 412 |
| Tear Strength | Die C | 31 | Pli | 5.55 | Kg/ | D 624 |
| | | | | | cm | |
| Hardness, | Shore A | 6 | | 6 | | D 2240 |
| 5 sec. delay | | | | | | |

### EXAMPLE 10

In order to produce a SIS/SBS blend thermoplastic elastomer gel, a preferred formula is:

| Vendor | Material Description | % by Weight |
|---|---|---|
| Dexco Polymers | VECTOR 2411 (SBS) | 22.0% |
| Dexco Polymers | VECTOR 4211 (SIS) | 11.0% |
| Witco | CARNATION Mineral Oil | 66.0% |
| Ciba Geigy | IRGANOX 1010 | 0.1% |
| Ciba Geigy | IRGAFOS 168 | 0.1% |
| Witco | Calcium Stearate | 0.5% |

What is claimed is:

1. An elastomer gel composition comprising:
(a) 100 parts by weight of a polymer component selected from the group consisting of SBS (styrene-butadiene-styrene) block copolymers and polymer combinations including a SBS (styrene-butadiene-styrene) block copolymer; and
(b) from about 100 to about 500 parts by weight of plasticizing oil.

2. An elastomer gel composition comprising:
(a) 100 parts by weight of a polymer component selected from the group consisting of SBS (styrene-butadiene-styrene) block copolymers and polymer combinations including a SBS (styrene-butadiene-styrene) block copolymer; and
(b) from about 100 to about 560 parts by weight of plasticizing oil.

3. The elastomer gel composition according to claim 1 wherein the SBS block copolymer is characterized by a molecular weight of at least 90,000 MW.

4. An article formed from the elastomer gel composition of claim 1 wherein said article exhibits low tack qualities.

5. An elastomer gel composition comprising:
(a) 100 parts by weight of a polymer component selected from the group consisting of SEBS (styrene-ethylene-butylene-styrene) block copolymers and polymer combinations including a SEBS (styrene-ethylene-butylene-styrene) block copolymer; and
(b) from about 100 to about 300 parts by weight of plasticizing oil.

6. An elastomer gel composition comprising:
(a) 100 parts by weight of a polymer component selected from the group consisting of SEPS (styrene-ethylene-propylene-styrene) block copolymers or any polymer combinations including a SEPS (group consisting of SEPS (styrene-ethylene-propylene-styrene) block copolymer; and
(b) from about 100 to about 500 parts by weight of plasticizing oil.

7. An elastomer gel composition comprising:
(a) 100 parts by weight of a polymer component selected from the group consisting of SEPS (styrene-ethylene-propylene-styrene) block copolymers or any polymer combinations including a SEPS (styrene-ethylene-propylene-styrene) block copolymer; and
(b) from about 100 to about 560 parts by weight of plasticizing oil.

8. An elastomer gel composition comprising:
(a) 100 parts by weight of a polymer combination including a SIS (styrene-isoprene-styrene) block copolymer; and
(b) from about 100 to about 500 parts by weight of plasticizing oil.

9. An elastomer gel composition comprising:
(a) 100 parts by weight of a polymer combination including a SIS (styrene-isoprene-styrene) block copolymer; and
(b) from about 100 to about 560 parts by weight of plasticizing oil.

10. The elastomer gel composition according to claim 1, further comprising up to 100 parts by weight of a polymer component selected from the group consisting of: SEBS (styrene-ethylene-butylene-styrene) block copolymers, polymer combinations including a SEBS (styrene-ethylene-butylene-styrene) block copolymer, SEPS (styrene-ethylene-propylene-styrene) block copolymers, and polymer combinations including a SEPS (styrene-ethylene-propylene-styrene) block copolymer.

11. The elastomer gel composition according to claim 1 wherein the plasticizing oil has an average molecular weight of between about 200 to about 700.

12. The elastomer gel composition according to claim 1 herein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

13. The elastomer gel composition according to claim 1 further comprising an additive.

14. The elastomer gel composition according to claim 13 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

15. The elastomer gel composition according to claim 1 further comprising at least about 30 to about 300 parts by weight of a magnetic additive.

16. The elastomer gel composition according to claim 15 wherein the magnetic additive is a ferrite complex.

17. The elastomer gel composition according to claim 15 wherein said elastomer gel composition holds a magnetic field.

18. A method of producing an elastomer gel composition, comprising:
(a) blending 100 parts by weight of a SBS (styrene-butadiene-styrene) block copolymer or any polymer combination including a SBS (styrene-butadiene-styrene) block copolymer with up to 100 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 500 parts by weight.

19. A method of producing an elastomer gel composition, comprising:
(a) blending 100 parts by weight of a SBS (styrene-butadiene-styrene) block copolymer or any polymer combination including a SBS (styrene-butadiene-styrene) block copolymer with up to 200 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 560 parts by weight.

20. A method of producing an elastomer gel composition, comprising:
(a) blending 100 parts by weight of a SEBS (styrene-ethylene-butylene-styrene) block copolymer or any polymer combination including a SEBS (styrene-ethylene-butylene-styrene) block copolymer with up to 100 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 500 parts by weight.

21. A method of producing an elastomer gel composition, comprising:
(a) blending 100 parts by weight of a SEBS (styrene-ethylene-butylene-styrene) block copolymer or any polymer combination including a SEBS (styrene-ethylene-butylene-styrene) block copolymer with up to 200 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 560 parts by weight.

22. A method of producing an elastomer gel composition, comprising:
(a) blending 100 parts by weight of a SEPS (styrene-ethylene-propylene-styrene) block copolymer or any polymer combination including a SEPS (styrene-ethylene-propylene-styrene) block copolymer with up to 100 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 500 parts by weight.

23. A method of producing an elastomer gel composition, comprising:
(a) blending 100 parts by weight of a SEPS (styrene-ethylene-propylene-styrene) block copolymer or any polymer combination including a SEPS (styrene-ethylene-propylene-styrene) block copolymer with up to 200 parts by weight of a plasticizing oil to produce a pre-blend;
(b) melting and masticating said pre-blend at about 200 to about 500° F.; and
(c) adding additional plasticizing oil to the pre-blend and further blending the mixture at a temperature of about 200° to about 500° F., whereas the total amount of plasticizing oil does not exceed 560 parts by weight.

24. The method of producing an elastomer gel composition according to claim 18 wherein the plasticizing oil has an average molecular weight of about 200 to about 700.

25. The method of producing an elastomer gel composition according to claim 18 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

26. The method of producing an elastomer gel composition according to claim 18 further comprising adding an additive to the gel composition during melting and mastication.

27. The method of producing an elastomer gel composition according to claim 26 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

28. An elastomer gel composition formed according to the method of claim 18.

29. The method of producing an elastomer gel composition according to claim 18 further comprising:
(a) adding a magnetic additive to the gel composition during melting and mastication; and
(b) orienting the elastomer gel composition containing magnetic additives through a powerful magnetic field.

30. The method of producing an elastomer gel composition according to claim 29 wherein the magnetic additive is a ferrite complex.

31. An elastomer gel composition formed according to the method of claim 29 wherein the elastomer composition holds a magnetic field.

32. The elastomer gel composition according to claim 2 wherein the SBS block copolymer is characterized by a molecular weight of at least 90,000 MW.

33. An article formed from the elastomer gel composition of claim 2 wherein said article exhibits low tack qualities.

34. The elastomer gel composition according to claim 2, further comprising up to 100 parts by weight of a polymer component selected from the group consisting of: SEBS (styrene-ethylene-butylene-styrene) block copolymers, polymer combinations including a SEBS (styrene-ethylene-butylene-styrene) block copolymer, SEPS (styrene-ethylene-propylene-styrene) block copolymers, and polymer combinations including a SEPS (styrene-ethylene-propylene-styrene) block copolymer.

35. The elastomer gel composition according to claim 2 wherein the plasticizing oil has an average molecular weight of between about 200 to about 700.

36. The elastomer gel composition according to claim 5 wherein the plasticizing oil has an average molecular weight of between about 200 to about 700.

37. The elastomer gel composition according to claim 6 wherein the plasticizing oil has an average molecular weight of between about 200 to about 700.

38. The elastomer gel composition according to claim 7 wherein the plasticizing oil has an average molecular weight of between about 200 to about 700.

39. The elastomer gel composition according to claim 8 wherein the plasticizing oil has an average molecular weight of between about 200 to about 700.

40. The elastomer gel composition according to claim 9 wherein the plasticizing oil has an average molecular weight of between about 200 to about 700.

41. The elastomer gel composition according to claim 10 wherein the plasticizing oil has an average molecular weight of between about 200 to about 700.

42. The elastomer gel composition according to claim 2 herein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

43. The elastomer gel composition according to claim 5 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

44. The elastomer gel composition according to claim 6 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

45. The elastomer gel composition according to claim 7 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

46. The elastomer gel composition according to claim 8 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

47. The elastomer gel composition according to claim 9 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

48. The elastomer gel composition according to claim 10 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

49. The elastomer gel composition according to claim 2 further comprising an additive.

50. The elastomer gel composition according to claim 49 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

51. The elastomer gel composition according to claim 5 further comprising an additive.

52. The elastomer gel composition according to claim 51 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

53. The elastomer gel composition according to claim 6 further comprising an additive.

54. The elastomer gel composition according to claim 53 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

55. The elastomer gel composition according to claim 7 further comprising an additive.

56. The elastomer gel composition according to claim 55 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

57. The elastomer gel composition according to claim 8 further comprising an additive.

58. The elastomer gel composition according to claim 57 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

59. The elastomer gel composition according to claim 9 further comprising an additive.

60. The elastomer gel composition according to claim 59 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

61. The elastomer gel composition according to claim 10 further comprising an additive.

62. The elastomer gel composition according to claim 61 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

63. The elastomer gel composition according to claim 2 further comprising at least about 30 to about 300 parts by weight of a magnetic additive.

64. The elastomer gel composition according to claim 63 wherein the magnetic additive is a ferrite complex.

65. The elastomer gel composition according to claim 63 wherein said elastomer gel composition holds a magnetic field.

66. The elastomer gel composition according to claim 5 further comprising at least about 30 to about 300 parts by weight of a magnetic additive.

67. The elastomer gel composition according to claim 66 wherein the magnetic additive is a ferrite complex.

68. The elastomer gel composition according to claim 66 wherein said elastomer gel composition holds a magnetic field.

69. The elastomer gel composition according to claim 6 further comprising at least about 30 to about 300 parts by weight of a magnetic additive.

70. The elastomer gel composition according to claim 69 wherein the magnetic additive is a ferrite complex.

71. The elastomer gel composition according to claim 69 wherein said elastomer gel composition holds a magnetic field.

72. The elastomer gel composition according to claim 7 further comprising at least about 30 to about 300 parts by weight of a magnetic additive.

73. The elastomer gel composition according to claim 72 wherein the magnetic additive is a ferrite complex.

74. The elastomer gel composition according to claim 72 wherein said elastomer gel composition holds a magnetic field.

75. The elastomer gel composition according to claim 8 further comprising at least about 30 to about 300 parts by weight of a magnetic additive.

76. The elastomer gel composition according to claim 75 wherein the magnetic additive is a ferrite complex.

77. The elastomer gel composition according to claim 75 wherein said elastomer gel composition holds a magnetic field.

78. The elastomer gel composition according to claim 9 further comprising at least about 30 to about 300 parts by weight of a magnetic additive.

79. The elastomer gel composition according to claim 78 wherein the magnetic additive is a ferrite complex.

80. The elastomer gel composition according to claim 78 wherein said elastomer gel composition holds a magnetic field.

81. The elastomer gel composition according to 10 further comprising at least about 30 to about 300 parts by weight of a magnetic additive.

82. The elastomer gel composition according to claim 81 wherein the magnetic additive is a ferrite complex.

83. The elastomer gel composition according to claim 81 wherein said elastomer gel composition holds a magnetic field.

84. The method of producing an elastomer gel composition according to claim 19 wherein the plasticizing oil has an average molecular weight of about 200 to about 700.

85. The method of producing an elastomer gel composition according to claim 20 wherein the plasticizing oil has an average molecular weight of about 200 to about 700.

86. The method of producing an elastomer gel composition according to claim 21 wherein the plasticizing oil has an average molecular weight of about 200 to about 700.

87. The method of producing an elastomer gel composition according to claim 22 wherein the plasticizing oil has an average molecular weight of about 200 to about 700.

88. The method of producing an elastomer gel composition according to claim 23 wherein the plasticizing oil has an average molecular weight of about 200 to about 700.

89. The method of producing an elastomer gel composition according to claim 19 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

90. The method of producing an elastomer gel composition according to claims 20 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

91. The method of producing an elastomer gel composition according to claim 21 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

92. The method of producing an elastomer gel composition according to claim 22 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

93. The method of producing an elastomer gel composition according to claim 23 wherein the plasticizing oil is selected from the group consisting of paraffinic oils, mineral oils, napthenic oils, synthetic polybutene oils, synthetic polypropene oils, synthetic polyterpene oils, aromatic oils, resins and mixtures thereof.

94. The method of producing an elastomer gel composition according to claim 19 further comprising adding an additive to the gel composition during melting and mastication.

95. The method of producing an elastomer gel composition according to claim 94 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

96. The method of producing an elastomer gel composition according to claim 20 further comprising adding an additive to the gel composition during melting and mastication.

97. The method of producing an elastomer gel composition according to claim 96 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

98. The method of producing an elastomer gel composition according to claims 21 further comprising adding an additive to the gel composition during melting and mastication.

99. The method of producing an elastomer gel composition according to claim 98 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

100. The method of producing an elastomer gel composition according to claim 22 further comprising adding an additive to the gel composition during melting and mastication.

101. The method of producing an elastomer gel composition according to claim 100 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

102. The method of producing an elastomer gel composition according to claim 23 further comprising adding an additive to the gel composition during melting and mastication.

103. The method of producing an elastomer gel composition according to claim 102 wherein the additive is selected from the group consisting of blowing agents, chemical foaming agents, phase change materials, magnetic particles, stabilizers and antioxidants, lubricants, waxes, fillers, minerals, emollients, antibacterial agents, flame retardants, colorants, antistatic agents, conductive additives, anti-blocking agents, fragrances, polymers and mixtures thereof.

104. An elastomer gel composition formed according to the method of claim 19.

105. An elastomer gel composition formed according to the method of claim 20.

106. An elastomer gel composition formed according to the method of claim 21.

107. An elastomer gel composition formed according to the method of claim 22.

108. An elastomer gel composition formed according to the method of claim 23.

109. The method of producing an elastomer gel composition according to claim 19 further comprising:
(a) adding a magnetic additive to the gel composition during melting and mastication; and
(b) orienting the elastomer gel composition containing magnetic additives through a powerful magnetic field.

110. The method of producing an elastomer gel composition according to claim 109 wherein the magnetic additive is a ferrite complex.

111. An elastomer gel composition formed according to the method of claim 109 wherein the elastomer composition holds a magnetic field.

112. The method of producing an elastomer gel composition according to claim 20 further comprising:
(a) adding a magnetic additive to the gel composition during melting and mastication; and
(b) orienting the elastomer gel composition containing magnetic additives through a powerful magnetic field.

113. The method of producing an elastomer gel composition according to claim 112 wherein the magnetic additive is a ferrite complex.

114. An elastomer gel composition formed according to the method of claim 112 wherein the elastomer composition holds a magnetic field.

115. The method of producing an elastomer gel composition according to claim 21 further comprising:
(a) adding a magnetic additive to the gel composition during melting and mastication; and
(b) orienting the elastomer gel composition containing magnetic additives through a powerful magnetic field.

116. The method of producing an elastomer gel composition according to claim 115 wherein the magnetic additive is a ferrite complex.

117. An elastomer gel composition formed according to the method of claim 115 wherein the elastomer composition holds a magnetic field.

118. The method of producing an elastomer gel composition according to claim 22 further comprising:
(a) adding a magnetic additive to the gel composition during melting and mastication; and
(b) orienting the elastomer gel composition containing magnetic additives through a powerful magnetic field.

119. The method of producing an elastomer gel composition according to claim 118 wherein the magnetic additive is a ferrite complex.

120. An elastomer gel composition formed according to the method of claim 118 wherein the elastomer composition holds a magnetic field.

121. The method of producing an elastomer gel composition according to claim 23 further comprising:
(a) adding a magnetic additive to the gel composition during melting and mastication; and
(b) orienting the elastomer gel composition containing magnetic additives through a powerful magnetic field.

122. The method of producing an elastomer gel composition according to claim 121 wherein the magnetic additive is a ferrite complex.

123. An elastomer gel composition formed according to the method of claim 121 wherein the elastomer composition holds a magnetic field.

124. The method according to claim 18 wherein the pre-blend is melted and masticated at about 200-350° F. further blending of the mixture after adding additional plasticizing oil is at about 200-350° F. and further comprising the addition of phase change materials.

125. The method according to claim 19 wherein the pre-blend is melted and masticated at about 200-350° F., further blending of the mixture after adding additional plasticizing oil is at about 200-350° F. and further comprising the addition of phase change materials.

126. The method according to claim 20 wherein the pre-blend is melted and masticated at about 200-350° F. further blending of the mixture after adding additional plasticizing oil is at about 200-350° F. and further comprising the addition of phase change materials.

127. The method according to claim 21 wherein the pre-blend is melted and masticated at about 200-350° F., further blending of the mixture after adding additional plasticizing oil is at about 200-350° F. and further comprising the addition of phase change materials.

128. The method according to claim 22 wherein the pre-blend is melted and masticated at about 200-350° F., further blending of the mixture after adding additional plasticizing oil is at about 200-350° F. and further comprising the addition of phase change materials.

129. The method according to claim 23 wherein the pre-blend is melted and masticated at about 200-350° F., further blending of the mixture after adding additional plasticizing oil is at about 200-350° F. and further comprising the addition of phase change materials.

130. An elastomer gel composition formed according to the method of claim 124.

131. An elastomer gel composition formed according to the method of claim 125.

132. An elastomer gel composition formed according to the method of claim 126.

133. An elastomer gel composition formed according to the method of claim 127.

134. An elastomer gel composition formed according to the method of claim 128.

135. An elastomer gel composition formed according to the method of claim 129.

136. The elastomer gel composition according to claim 1, further comprising between about 0.1 to about 2.0 parts by weight of a stabilizer, the addition of said stabilizer yielding a thermoplastic elastomer gel composition which exhibits low tack.

137. The elastomer gel composition according to claim 2, further comprising between about 0.1 to about 2.0 parts by weight of a stabilizer, the addition of said stabilizer yielding a thermoplastic elastomer gel composition which exhibits low tack.

138. The elastomer gel composition according to claim 5, further comprising between about 0.1 to about 2.0 parts by weight of a stabilizer, the addition of said stabilizer yielding a thermoplastic elastomer gel composition which exhibits low tack.

139. The elastomer gel composition according to claim 6, further comprising between about 0.1 to about 2.0 parts by weight of a stabilizer, the addition of said stabilizer yielding a thermoplastic elastomer gel composition which exhibits low tack.

140. The elastomer gel composition according to claim 7, further comprising between about 0.1 to about 2.0 parts by weight of a stabilizer, the addition of said stabilizer yielding a thermoplastic elastomer gel composition which exhibits low tack.

141. The elastomer gel composition according to claim 8, further comprising between about 0.1 to about 2.0 parts by weight of a stabilizer, the addition of said stabilizer yielding a thermoplastic elastomer gel composition which exhibits low tack.

142. The elastomer gel composition according to claim 9, further comprising between about 0.1 to about 2.0 parts by weight of a stabilizer, the addition of said stabilizer yielding a thermoplastic elastomer gel composition which exhibits low tack.

143. The elastomer gel composition according to claim 10, further comprising between about 0.1 to about 2.0 parts by weight of a stabilizer, the addition of said stabilizer yielding a thermoplastic elastomer gel composition which exhibits low tack.

144. The elastomer gel composition according to claim 1, further comprising between about 0.1 to about 2.0 parts by weight of a lubricant, the addition of said lubricant yielding a thermoplastic elastomer gel composition which exhibits low tack.

145. The elastomer gel composition according to claim 2, further comprising between about 0.1 to about 2.0 parts by weight of a lubricant, the addition of said lubricant yielding a thermoplastic elastomer gel composition which exhibits low tack.

146. The elastomer gel composition according to claim 5, further comprising between about 0.1 to about 2.0 parts by weight of a lubricant, the addition of said lubricant yielding a thermoplastic elastomer gel composition which exhibits low tack.

147. The elastomer gel composition according to claim 6, further comprising between about 0.1 to about 2.0 parts by weight of a lubricant, the addition of said lubricant yielding a thermoplastic elastomer gel composition which exhibits low tack.

148. The elastomer gel composition according to claim 7, further comprising between about 0.1 to about 2.0 parts by weight of a lubricant, the addition of said lubricant yielding a thermoplastic elastomer gel composition which exhibits low tack.

149. The elastomer gel composition according to claim 8, further comprising between about 0.1 to about 2.0 parts by weight of a lubricant, the addition of said lubricant yielding a thermoplastic elastomer gel composition which exhibits low tack.

150. The elastomer gel composition according to claim 9, further comprising between about 0.1 to about 2.0 parts by weight of a lubricant, the addition of said lubricant yielding a thermoplastic elastomer gel composition which exhibits low tack.

151. The elastomer gel composition according to claim 10, further comprising between about 0.1 to about 2.0 parts by weight of a lubricant, the addition of said lubricant yielding a thermoplastic elastomer gel composition which exhibits low tack.
